(19) United States
(12) Patent Application Publication
(10) Pub. No.: US 2006/0235566 A1
(43) Pub. Date: Oct. 19, 2006

(54) Arrangement for programming a system-independent measurement system for work pieces

(75) Inventor: Karl J. Lenz, Wiesbader (DE)

Correspondence Address: Stephen B. Salai, Esq.;Harter, Secrest & Emery LLP, 1600 Bausch & Lomb Place, Rochester, NY, 14604-2711, US

(73) Assignee: Quality Vision International, Inc., Rochester, NY (US)

(21) Appl. No.: 11/404,277

(22) Filed: Apr. 14, 2006

(30) Foreign Application Priority Data
Apr. 18, 2005 (DE) 102005017940.1-52

(51) Int. Cl. G06F 19/00

(52) U.S. Cl. 700/195; 382/141

(57) ABSTRACT

The invention relates to an arrangement for system-independent (off-line) programming of a measurement system for work pieces that includes a video measurement module and an evaluator. The arrangement according to the invention makes use of the evaluator of the measurement system or a similarly configured device. Instead of the video output signal of the video measuring unit that images actual work pieces, the video output signal of a system-independent programming apparatus is transferred to the evaluator of the measurement system. In a preferred embodiment, the programming apparatus is a personal computer with a display device, whereby the personal computer is loaded with a program for processing CAD data that describes a work piece, and for displaying on the display device various images of the work piece that are selected by the user. The functional principle of the arrangement according to the invention is that instead of a real image of the work piece taken by the video measurement module, the evaluator of the measurement system evaluates a virtual video image that is generated based on the CAD data that is available for the work piece.

### BACKGROUND OF THE INVENTION

1. Field of the Invention

The invention relates to video-based measurement systems for work pieces and, in particular, to the programming of such video-based measuring systems for measuring different work pieces.

2. Description of Related Art

Various measurement systems for measuring structures of a work piece are known that possess a measurement module with a mechanical contact probe or video camera with which the coordinates of the structures are captured. In optical coordinate measurement systems, a video camera images the surface of the work piece. The video camera generates an output signal that describes the image taken of the work piece. For outputting the video output signal, the video measurement module includes an output module with a standardized interface.

Typically, the video measurement modules of the known measurement systems make available a standardized analog TV-video signal at the output module, which in principle enables reproduction on a TV device. The known standards include PAL (Phase Alternating Line standard) and NTSC (National Television System Committee standard).

In addition to the video measurement modules, the known measurement systems include evaluators. The evaluators include an input module for inputting the analog video output signal of the video camera, and a driver device for reproducing on a display device, such as a monitor, the image of the work piece taken by the video measurement module. Data transfers between the output module of the video measurement module and the input module of the evaluator take place via a conventional video cable.

Another component of the evaluators is an image analysis device that enables one to recognize the structures to be measured in the image of the work piece. This image analysis device makes use of known image recognition programs. Measurement of the structures is implemented using a measurement device with which the dimensions of the specified geometrical structures are determined.

The known measurement systems can be used to monitor the quality of work pieces that are produced in large production runs. Because of this, measurements are preferably completely automatic.

Programmable measurement systems for work pieces are known that (a) recognize specified structures of the work piece in a preset sequence according to a preset program flow and (b) determine the dimensions of the structures. This generally requires the measurement system to be programmable. For programming, the user selects the structures of the video captured work pieces to be measured in a preset sequence.

It is disadvantageous that the measurement system is not available for quality control during programming. As a result, continuous operation requires the relatively costly acquisition of at least two measurement systems, each comprising a video measuring unit and an evaluator.

One objective of the invention is to make available an arrangement that permits system-independent (off-line) programming of video-based measurement systems for work pieces. In addition, it is an objective to provide equivalent video input to an evaluator for purposes of programming measurement steps for different work pieces for without requiring the different work pieces to be imaged.

### BRIEF SUMMARY OF THE INVENTION

According to one or more embodiments of the invention, system independent (off-line) programming of video measurement systems can be achieved without disrupting ongoing video measurements or even requiring the video imaging of actual work pieces. Virtual video images of the work pieces can be generated in accordance with the invention based on design specifications of the work pieces, and the virtual images can be presented for measurement in the form of a conventional video input signal.

Instead of obtaining real video images of the work pieces taken by the video measurement module, a programming device can be used to generate virtual video images of the work pieces based on the CAD (Computer Aided Design) data that is available for the work pieces. The video signal capturing the computer-generated images of the work pieces is intended to be of the same form as the video signal conveying real video images to an evaluator of the measurement system. As such, the evaluator responds to the computer-generated video images in substantially the same way as to real video images presented for programming. Feedback from the evaluator can be used to manipulate the virtual video images as if the image manipulations were performed on real work pieces.

The programming device can be obtained at relatively low cost in the form of a personal computer (PC) having the appropriate software for generating and manipulating video images from a data file. Software for evaluating the video images including image analysis and measurement software can reside on the same or a different programming device. However, a relatively costly video measurement module is not required for reprogramming the measurement system to measure new work pieces. The reprogramming can be carried out at a remote (i.e., more convenient) location without requiring the manipulation of actual work pieces or video measuring instruments, and the reprogramming can be transferred to conventional video measurement systems for measuring different work pieces without the usual on-line programming delays.

Software or other controls for operating the evaluator is preferably the same, regardless of whether the video image received for evaluation is produced by a video measurement module or by a computer image generator. Key to this is the video signal itself received by the evaluator, which preferably arrives in same form from either the video measurement module or the computer image generator. For example, the video signal can take an analog form according to known standards such as PAL (Phase Alternating Line standard) and NTSC (National Television System Committee standard), and as such, would otherwise be capable of reproduction by a conventional TV monitor.

The preferred arrangement according to the invention includes an apparatus for programming the measurement system. The apparatus for programming the measurement system can include a device for reading the CAD data (Computer Aided Design), which describes the geometrical dimensions of the work piece. Such data may be made available in various formats such as the known IGS, STEP, or DXF formats. The CAD data may be provided by known data storage mediums. For example, the device for reading the CAD data may be a disk drive.

In addition, the programming apparatus can include a device for processing CAD data and for displaying on demand different images of the work piece that may be selected by the user. As a result, the user can select images of the work piece that are relevant for measurement without having to image the work piece with a video measurement module.

Furthermore, the programming apparatus can include a device for generating a video output signal that describes the image of the work piece selected by the user. An output module of the programming apparatus can provide for outputting the video output signal in a form that is formally indistinguishable from the output signal of the video measurement module.

The output module of the programming apparatus can be connected to the input module of the evaluator via a data transfer device such that the evaluator of the programming system receives the video output signal of the programming apparatus rather than the video output signal of the video measurement module.

When programming, the programming apparatus can make use of an evaluator of the measurement system or a separate evaluator residing on the same or a different computer from the programming apparatus. System-independent (off-line) programming is thus accomplished similar to conventional on-line programming of the measurement system, one main difference being that the off-line programming can be carried out without access to a video measurement module or actual work pieces. Thus, programming delays for video measurement systems can be substantially reduced.

In a preferred embodiment, the evaluator, as a component of the arrangement for off-line programming of the measurement system, is a personal computer (PC) with a display device, whereby a program is also loaded in the personal computer for processing the CAD data that describes the work piece, and for representing on the display device various images of the work piece that are selected by the user. A standard commercial program can be used that displays of images of the work piece and not interior details of the work piece. However, standard commercial CAD programs with which the work pieces can be designed may also be loaded on the personal computer.

If the video measurement module of the measurement system for which the programming arrangement is provided has an output module for outputting an analog TV-video output signal according to the known standard (PAL or NTSC), the programming apparatus, which is a component of the arrangement for off-line programming of the measurement system, preferably includes a device for generating a similar analog video output signal. If a personal computer is used as the evaluator, a known PC-TV converter that is connected to the graphics card of the PC may be used. Such converters make it possible to connect a TV device or video recorder to a PC. They transform the VGA signal of the PC into PAL or NTSC signals as selected. Preferably, the VGA-TV converter possesses a device for automatically setting the output value and position of the image on the monitor.

Alternatively, if the video measurement module of the measurement system outputs a digital video output signal, the programming apparatus preferably includes a device for generating a similar digital video output signal, whereby the output module outputs the digital video output signal according to the same known standard.

Advantageously, the data transfer device can be a conventional connection cable. Such connection cables for the various standards are well known to persons skilled in the art. In principle, however, it is also possible to transfer the data as radio signals or optical signals. The data transfer device may be a component of a network. In addition, transfer of data may also be accomplished by data mediums.

The output module of the programming apparatus and the input module of the evaluator may be implemented at an interface that is customary in metrology, such as according to the l++ standard.

The programming apparatus of the arrangement according to the invention is preferably available as an independent unit. In principle, however, it is also possible to provide both the evaluator of the measurement system and the programming apparatus as a unit, for example, a personal computer on which two programs run independently of each other.

It is advantageous if both the programming apparatus and the evaluator possess different display devices such as monitors. In principle, however it is possible for all images to be displayed on only one monitor. The hardware and software required for this are known to persons skilled in the art.

An embodiment of the invention is explained in greater detail below with reference to the diagrams.

### BRIEF DESCRIPTION OF THE SEVERAL VIEWS OF THE DRAWING(S)

FIG. 1 a simplified schematic representation of the significant components of a known measurement system that comprises a video measurement module and an evaluator.

FIG. 2 a simplified schematic representation of the arrangement according to the invention for system-independent programming of the measurement system in FIG. 1.

### DETAILED DESCRIPTION OF THE INVENTION

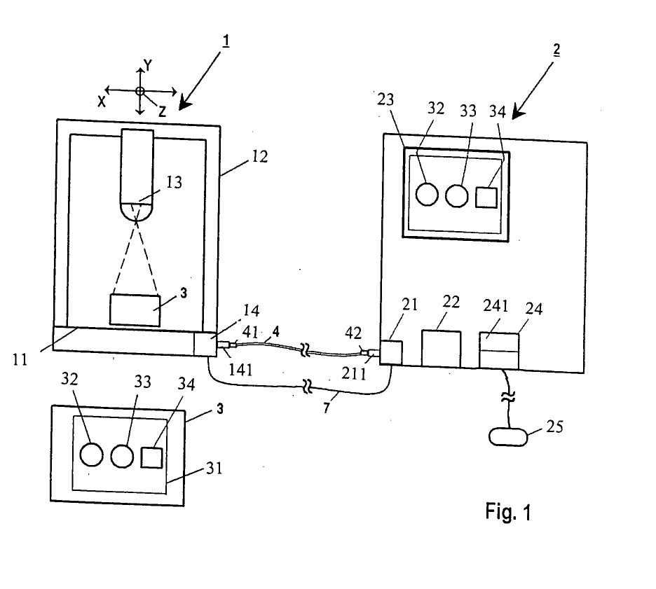

FIG. 1 shows a known measurement system for automatically measuring the structures of a work piece, in the form of a programmable coordinate measurement device. The measurement system comprises a video measurement module 1 and an evaluator 2 as two independent components that are connected to each other for the purpose of transferring pertinent data.

The video measurement module 1 comprises a measurement table 11 on which lies the work piece 3. A video camera 13 that is movable along the X- Y- and Z-axes for capturing the surface of the work piece 3 is provided on a frame 12 that is above the measurement table 11. The video camera 13 of the video measurement module 1 generates an analog PAL or NTSC video output signal that contains image data that describes an image of the work piece 3 that is taken by the video camera 13. The analog TV-video output signal in PAL or NTSC is output by an output module 14 that comprises a socket 141 for connecting the plug 41 of a video cable 4. In addition to the video signal, the video measurement module 1 provides a signal that indicates the X- Y-, and Z-coordinates of the midpoint of the image 3 captured by the video camera 13.

The evaluator 2 of the measurement system may comprise a PC with a monitor on which imaging analysis software is running. The evaluator 2 has an input module 21 for inputting the video output signal into the video measurement module 1. The input module 21 has a socket 211 to which the plug 42 of the video cable 4 is attached. In addition to the video signal, the evaluator receives the X- Y-, and Z-coordinate signals from the video measurement module 1. A data cable 7, which is attached to the video measurement module 1 and the evaluator 2, is provided for data transfer. For this purpose, the measurement module and the evaluator possess corresponding interfaces.

In addition, the evaluator 2 comprises a device 22 for displaying on the display device 23 the image of the work piece 3 that was taken by the video camera 13. The display device 23 in FIG. 1 shows the image 31 that was taken by the video measurement module 1 of the work piece 3. The structure to be measured is a circular recess 32, the radius of which is to be determined. Furthermore, the geometric dimensions of the other geometric structures 33, 34 of the work piece are to be determined in a sequence preset by the user. For this purpose, the video camera 13 is moved over the work piece along the X- Y-, and Z-axes. In order to measure the work piece structures, the evaluator possesses a measurement device 24 that includes an image analysis device 241 for recognizing the structures on the work piece that are specified by the user.

In order to program the measurement system, the structures to be measured 32, 33, and 34 of the work piece 3 are selected by the user in a preset sequence, such that the video camera 13 of the video measurement module 1 is moved over the work piece while the image 31 of the work piece in which the structure to be measured lies is viewed on the display device, and the structures to be measured are, for example, selected by clicking a computer mouse 25.

After the user has set the sequence of the structures of the work piece to be measured (programming), quality control assessments of the work pieces with the measurement system occurs substantially automatically. The values that are determined, such as spacing, diameter, or angle, are compared with the setpoints of the work piece, and the tolerances are output in a measurement report.

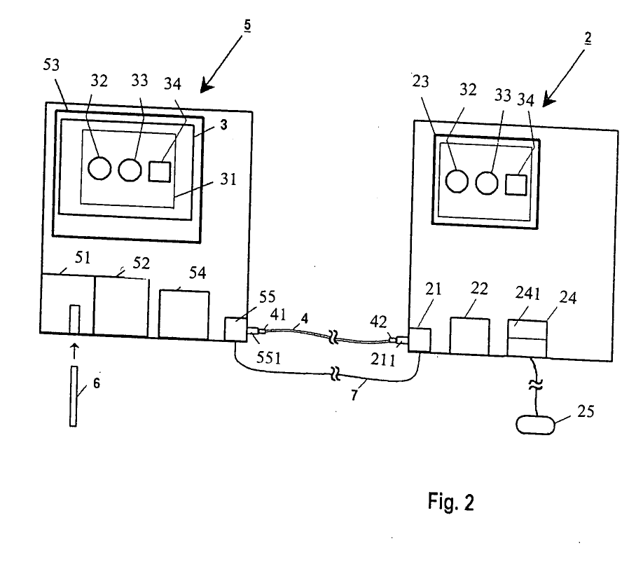

The arrangement according to the invention for system-independent (off-line) programming of the known measurement system is described below with reference to FIG. 2.

The off-line programming arrangement according to the invention makes use of the evaluator 2 of the known measurement system. Although the evaluator of the programming arrangement can be virtually identical to the evaluator of the above-described measurement system, the programming arrangement preferably includes a separate evaluator to enable remote programming independent of the measurement environment. The individual components of the evaluator 2, as well as of the known measurement system and of the arrangement according to the invention, are therefore given the same reference numbers. In addition to the evaluator 2, the arrangement according to the invention possesses a programming apparatus 5 for programming a measurement system, which preferably comprises an independent unit.

The programming apparatus 5 comprises a reading device 51 for reading the geometric dimensions of the CAD data that describe the work piece. The data may, for example, be provided on a diskette 6 and read into the programming apparatus. In addition, the programming apparatus 5 includes a processing device 52 for processing the CAD data and for displaying various images of the work piece, which may be selected by the user, on a display device 53. FIG. 2 displays on the display device 53 the image 31 of the work piece 3 that has been created using CAD data. The user selects from the video image an image 31 of the work piece that shows the structure 32 to be measured. The image 31 corresponds to the real video image, which the video measurement module 1 would otherwise capture.

In order to generate an analog TV-video output signal that contains image data that describe the image 31 of the work piece selected by the user, the programming apparatus possesses a further device 54 and an output module 55 with a plug 551 for outputting the video output signal. The output module 55 generates an analog TV-video output signal in PAL or NTSC, respectively.

The analog video output signal from the programming apparatus 5 rather than the video output signal of the video measurement module 1 is transferred to the evaluator 2 of the measurement system by means of a video cable 4 that is attached to the sockets 551 and 211 of the output module 55 of the programming apparatus 5, or of the input module 21 of the evaluator 2, respectively. The evaluator then enables programming of the measurement system in the customary manner as described above. Because the video measurement module 1 cannot be used during programming, the video measurement module is used together with a further evaluator for the purpose of implementing quality control measurements.

The programming apparatus 5 of the arrangement according to the invention may include a personal computer (PC) with a monitor, which runs a program for processing CAD data and for displaying the images of the work piece generated by the CAD data. The device for generating the analog video output signal is a standard commercial converter for transforming the VGA signal of the computer into a TV-video signal in PAL or NTSC. The selection of different images of the work piece may be accomplished in this manner using CAD software running on the PC and with the video measurement module. Thus, the movements of the video measurement module along the X- Y-, and Z-axes may be simulated in that the user presets a window such that the corresponding segment may be selected. Standard commercial CAD programs allow this, or it may be accomplished within the interfaces generally available in the CAD programs.

If not all of the structures to be measured are to be displayed on the display device 23 of the evaluator 2, the X- Y-, and Z-coordinates of the midpoint of the video image must be provided for the simulation. Provision of these coordinates may be accomplished using the programming apparatus 5 because the CAD program running on the personal computer provides the corresponding data anyway. These data may be transferred via a data line 7 from the programming apparatus 5 to the evaluator 2. The known interfaces are available for this purpose.

1. Arrangement for system-independent programming of a measurement system for work pieces, wherein the measurement system comprises:
a video measurement module for generating an output signal that contains image data that describes the image of a work piece taken by the video measurement module, whereby the video measurement module includes an output module for outputting the video output signal, and
an evaluator comprising:
an input device for inputting the video output signal from the video measurement module,
a display device for displaying on a display device the image of the work piece taken by the video measurement module, and
a measurement device for measuring structures, which comprises an image analysis device for recognizing structures in the image of the work piece, and
a data transfer device that may be attached to the output device of the video measurement module and to the input module of the evaluator for the purpose of transferring the video output signal from the video measurement module to the evaluator, and
wherein the arrangement for system-independent programming of the measurement system comprises:
the evaluator of the measurement system, and
a programming device for programming the measurement system, wherein the programming device for programming the measurement system comprises:
a device for reading CAD data that describe the geometric dimensions of the work piece,
a device for processing the CAD data and for displaying on a display device various images of the work piece that may be selected by the user,
an output device for generating a video output signal that contains image data that describe the image of the work piece selected by the user, and
an output module for outputting the video output signal,
wherein the data transfer device is attached to the input module of the evaluator of the measurement system and to the output device of the programming device, such that the evaluator of the measurement system receives the video output signal of the programming device for programming the measurement system.

2. Arrangement according to claim 1 in which the device for programming the measurement system comprises a personal computer (PC) with a display device, whereby the personal computer runs a program for processing CAD data that describes a work piece and for displaying on the display device various images of the work piece selected by the user

3. Arrangement according to claim 2 in which the personal computer comprises a device for generating and analog video output signal, whereby the input module of the evaluator of the measurement system is an analog input module.

4. Arrangement according to claim 3 in which the device for generating an analog video output signal is a converter for transforming a VGA signal into a TV-video signal.

5. Arrangement according to claim 4 in which the analog video output signal is a PAL or NTSC video signal.

6. Arrangement according to claim 1 in which the input module of the evaluator of the measurement system is a digital input module.

7. Arrangement according to one of claim 1 in which the data transfer device is a connection cable that may be attached to the input module of the evaluator of the measurement system and to the output module of the apparatus for programming the measurement system.

8. Arrangement according to claim 1 in which the display device of the apparatus for programming the measurement system is a display monitor.

9. Arrangement for system-independent programming of a video measurement system for work pieces comprising:
a programming apparatus including:
a reading device for reading CAD data that describes the geometric dimensions of a work piece,
a processing device for processing the CAD data and for generating different images of the work piece that may be selected by a user, and
an output device for generating a video output signal that contains image data that describes the image of the work piece selected by the user,
an evaluator including:
an input device for inputting the video output signal from the programming apparatus.
a display device for displaying on a display device the images of the work piece generated by the processing device, and
a measurement device for measuring structures, which comprises an image analysis device for recognizing structures in the image of the work piece, and
a data transfer device between the output device of the programming apparatus and the input device of the evaluator for conveying video images to the evaluator and conveying user selections to the programming apparatus.

10. A programming system for a video measurement system having a video measurement module and a video evaluator that receive video images from the video measurement module for evaluation comprising:
a programming apparatus that generates video images of a work piece from design specifications of the work piece,
an output device that outputs the video images from the programming apparatus in a signal form matching a signal form of video images transmitted from the video measurement module to the video evaluator, and
a programming evaluator that receives the video images from the programming apparatus in the signal form that matches the signal form of the video images transmitted to the video evaluator for programming a measurement sequence for evaluating actual work pieces against the design specifications for the work piece.
